(19) United States
(12) Patent Application Publication
(10) Pub. No.: US 2025/0155262 A1
(43) Pub. Date: May 15, 2025

(54) METHOD AND SYSTEM FOR UPDATING NAVIGATION DATA

(71) Applicant: HYUNDAI AUTOEVER CORP., Seoul (KR)

(72) Inventors: Young Hurck Cha, Seoul (KR); Sang Woo Kim, Seoul (KR)

(73) Assignee: HYUNDAI AUTOEVER CORP., Seoul (KR)

(21) Appl. No.: 18/940,523

(22) Filed: Nov. 7, 2024

(30) Foreign Application Priority Data
Nov. 9, 2023 (KR) 10-2023-0154234

(51) Int. Cl. G01C 21/00

(52) U.S. Cl. CPC G01C 21/3893

(57) ABSTRACT

A method for updating navigation data may be performed by a computing device. The method may include establishing connection between a charging station and a vehicle system; obtaining information of the vehicle system that includes an expected charging time of the vehicle and version information of map data of the vehicle system; determining an updating target range of the map data based on the information of the vehicle system; and updating the map data based on the updating target range of the map data.

### CROSS-REFERENCE TO RELATED APPLICATION

This application claims priority to Korean Patent Application No. 10-2023-0154234 filed on Nov. 9, 2023, in the Korean Intellectual Property Office, and all the benefits accruing therefrom under 35 U.S.C. 119, the contents of which in its entirety are incorporated herein by reference.

### TECHNICAL FIELD

The present disclosure relates to a method and system for updating navigation data. More specifically, the present disclosure relates to a method and system for updating map data through communication between a charging station and a vehicle. Furthermore, the present disclosure relates to a method and system for updating map data through communication between vehicles.

### BACKGROUND

In providing a navigation service, a route guidance method based on the latest map data is one of the important elements for finding an optimal route from a starting point to a destination. Conventionally, there was a problem that separate time and cost for software updates were required because a user had to manually perform periodic software updates in order to obtain the latest map data.

The statements in this Background section merely provide background information related to the present disclosure and may not constitute prior art.

### SUMMARY

A technical purpose to be achieved in accordance with some embodiments of the present disclosure is to provide a method and system for updating a navigation device embedded in a vehicle system through communication between a charging station and a vehicle while power is supplied to the vehicle from the charging station.

Another technical purpose to be achieved in accordance with some embodiments of the present disclosure is to provide a method and system for updating a navigation device embedded in a vehicle system through communication between vehicles while the vehicle is driving or stopped.

Still another technical purpose to be achieved in accordance with some embodiments of the present disclosure is to provide a method and system for updating navigation data in which appropriate contents is provided to a user while map data of a navigation device embedded in a vehicle system is being updated while power is supplied to the vehicle from the charging station.

Still yet another technical purpose to be achieved in accordance with some embodiments of the present disclosure is to provide a method and system for updating navigation data in which a reward for providing map data is allocated to a user who has provided map data when updating map data of a navigation device embedded in a vehicle system through vehicle-to-vehicle communication.

Still yet another technical purpose to be achieved in accordance with some embodiments of the present disclosure is to provide a method and system for updating navigation data in which map data of a location positioned close to a driving route set by a user is updated at top priority when updating map data of a navigation device embedded in a vehicle system through vehicle-to-vehicle communication.

The technical purposes of the present disclosure are not limited to the technical purposes mentioned above, and other technical purposes not mentioned may be clearly understood by those having ordinary skill in the art from descriptions as set forth below.

According to an aspect of the present closure, a method for updating navigation data may be performed by a computing device. The method may include establishing connection between a charging station and a vehicle system; obtaining information of the vehicle system including an expected charging time of the vehicle and version information of map data of the vehicle system; determining an updating target range of the map data based on the information of the vehicle system; and updating the map data based on the updating target range of the map data.

In some embodiments, the information of the vehicle system may include personal schedule information registered in the vehicle system.

In some embodiments, establishing the connection may include receiving, from the vehicle system, a signal indicating whether or not to allow access to the vehicle system.

In some embodiments, determining the updating target range of the map data may include determining contents able to be entirely played within the expected charging time.

In some embodiments, updating the map data may include providing the determined contents to the vehicle system during the expected charging time.

In some embodiments, determining the updating target range of the map data may include transmitting, to the vehicle system, a list of contents able to be provided to the vehicle system; receiving, from the vehicle system, first contents selected from the list by the vehicle system; comparing a playback time of the first contents with the expected charging time; and determining the updating target range of the map data, based on a result of comparing the playback time of the first contents with the expected charging time.

In some embodiments, determining the updating target range of the map data, based on the result of comparing the playback time of the first contents with the expected charging time may include upon determination that the playback time is less than the expected charging time, determining the updating target range of the map data based on the playback time.

In some embodiments, updating the map data may include playing back the first contents during the playback time.

In some embodiments, the information of the vehicle system may include information on a driving route set by the vehicle system. Determining the updating target range of the map data includes determining the updating target range of the map data based on the driving route set by the vehicle system.

In some embodiments, updating the map data may include: when updating the map data based on the updating target range has not been completed, determining whether the vehicle system proceeds with updating the map data; and upon determination that the vehicle system proceeds with updating the map data, proceeding with updating the map data, and, at the same time, transmitting an expected time required for completion of updating the map data and a progress percentage of updating the map data to the vehicle system.

In some embodiments, updating the map data may include: when updating the map data based on the updating target range has not been completed, determining whether the vehicle system proceeds with updating the map data; and upon determination that the vehicle system does not proceed with updating the map data, cancelling updating the map data, and, at the same time, transmitting an expected time required for completion of updating the map data to the vehicle system.

According to another aspect of the present closure, a method for updating navigation data may be performed by a computing device. The method may include receiving a request of updating map data from a first navigation device, wherein the first navigation device is configured to receive a navigation service provided from the computing device; determining a second navigation device, wherein the second navigation device stores therein at least a portion of the map data, has a current driving route matching at least a portion of a current driving route of the first navigation device, and has a current position adjacent to a current position of the first navigation device within a reference value, wherein the second navigation device is configured to receive the navigation service provided from the computing device; and transmitting access information about the second navigation device to the first navigation device.

In some embodiments, determining the second navigation device may include receiving a signal indicating whether the second navigation device accepts providing the map data in response to the request of updating the map data.

In some embodiments, receiving the signal indicating whether the second navigation device accepts providing the map data may include: upon receiving the signal indicating that the second navigation device accepts providing the map data, providing a first driving speed to the second navigation device; and when a vehicle of the second navigation device complies with the first driving speed, providing a first reward to the vehicle of the second navigation device.

In some embodiments, receiving the signal indicating whether the second navigation device accepts providing the map data may include transmitting information about the first reward to the second navigation device.

In some embodiments, providing the first reward may include providing the first reward to the vehicle of the second navigation device even when updating the map data has not been completed due to an abnormal behavior of a driver of a vehicle of the first navigation device.

In some embodiments, receiving the signal indicating whether the second navigation device accepts providing the map data may include: upon receiving the signal indicating that the second navigation device accepts providing the map data, providing a first driving route to the second navigation device; and when a vehicle of the second navigation device complies with the first driving route, providing a second reward to a vehicle of the second navigation device.

In some embodiments, receiving the signal indicating whether the second navigation device accepts providing the map data may include transmitting information about the second reward to the second navigation device.

In some embodiments, providing the second reward may include providing the second reward to the vehicle of the second navigation device even when the updating of the map data has not been completed due to an abnormal behavior of a driver of a vehicle of the first navigation device.

According to still another aspect of the present closure, a system for updating navigation data may include a communication interface; a memory configured to load thereon a computer program; and at least one processor configured to execute the computer program. In particular, the at least one processor is configured to execute the computer program to: establish connection between a charging station and a vehicle system; obtain information of the vehicle system, the information including an expected charging time of the vehicle and version information of map data of the vehicle system; determine an updating target range of the map data based on the information of the vehicle system; and update the map data based on the updating target range of the map data.

### BRIEF DESCRIPTION OF DRAWINGS

The above and other aspects and features of the present disclosure should become more apparent by describing in detail illustrative embodiments thereof with reference to the attached drawings, in which:

FIG. 1 is a configuration diagram of a system for updating navigation data according to an embodiment of the present disclosure;

FIG. 2 is a flow chart of a method for updating navigation data according to an embodiment of the present disclosure;

FIG. 3 is a signal flow diagram illustrating a method for updating navigation data according to an embodiment of the present disclosure;

FIG. 4 is a diagram illustrating a user screen for performing a method for updating navigation data according to an embodiment of the present disclosure;

FIG. 5 is a diagram illustrating detailed operations of the method for updating navigation data, as described above with reference to FIG. 2;

FIG. 6 is a diagram illustrating a method for applying the method for updating the navigation data according to an embodiment of the present disclosure;

FIG. 7 is a diagram illustrating detailed operations of the method for updating navigation data, as described above with reference to FIG. 2;

FIG. 8 is a configuration diagram of a system for updating navigation data according to an embodiment of the present disclosure;

FIG. 9 is a flow chart of a method for updating navigation data according to an embodiment of the present disclosure;

FIGS. 10-12 are diagrams illustrating a user screen for performing a method for updating navigation data according to an embodiment of the present disclosure; and

FIG. 13 is a hardware configuration diagram of a computing system described in some embodiments of the present disclosure.

The drawings described herein are for illustration purposes only and are not intended to limit the scope of the present disclosure in any way.

### DETAILED DESCRIPTIONS

Hereinafter, embodiments of the present disclosure are described with reference to the attached drawings. Advantages and features of the present disclosure and methods of accomplishing the same may be understood more readily by reference to the following detailed description of embodiments and the accompanying drawings. The present disclosure may, however, be embodied in many different forms and should not be construed as being limited to the embodiments set forth herein. Rather, these embodiments are provided so that this disclosure is thorough and complete and fully conveys the concept of the disclosure to those having ordinary skill in the art, and the present disclosure is only defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof has been omitted.

Unless otherwise defined, all terms used in the present specification (including technical and scientific terms) may be used in a sense that can be commonly understood by those having ordinary skill in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component. When a component, controller, device, unit, module, processor element, apparatus, or the like of the present disclosure is described as having a purpose or performing an operation, function, or the like, the component, controller, device, unit, module, processor element, apparatus, or the like should be considered herein as being “configured to” meet that purpose or to perform that operation or function.

Hereinafter, several embodiments of the present disclosure are described with reference to the drawings.

A method for updating navigation data according to the present embodiment may be performed by one or more computing devices. Furthermore, some operations of the method for updating navigation data according to the present embodiment may be performed by a first computing device included in a system for updating the navigation data, and the remaining operations thereof may be performed by a second computing device included in a navigation system. For example, some operations of the method for updating navigation data according to the present embodiment may be performed by an on-premise physical server, and the remaining operations thereof may be performed by a cloud compute instance. Hereinafter, it may be understood that when an entity performing each operation is omitted, the performing entity may be the system for updating the navigation data.

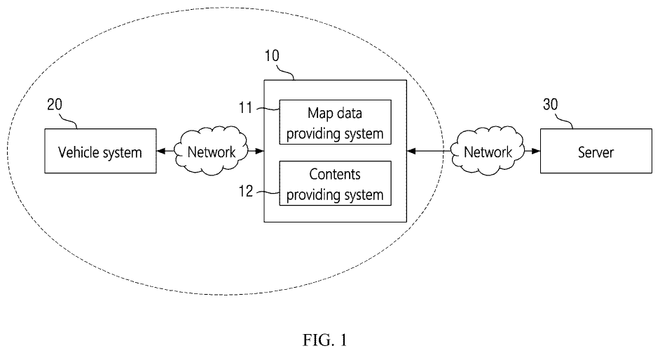

FIG. 1 is a configuration diagram of a system for updating navigation data according to an embodiment of the present disclosure.

Referring to FIG. 1, a system for updating navigation data may include a charging station 10, a vehicle system 20, and a server 30. The charging station 10 may include a map data providing system 11 and a contents providing system 12.

The charging station 10 may be a gas or electrical charging station, a rest station, and the like. When a vehicle equipped with a vehicle system 20 approaches the charging station 10 by a distance at which short-range communication is established between the charging station 10 and the vehicle system 20, the charging station 10 may attempt to connect to the vehicle system 20 and transmit map data as an updating target to the vehicle system 20 or transmit various contents thereto. Any short-range communication scheme may be available as long as it uses a short-range communication network. One example thereof may be Wi-Fi.

The map data providing system 11 in the charging station 10 may receive and store the latest map data from the server 30 and transmit the latest map data to the vehicle system 20. The contents providing system 12 may receive and store the latest contents from the server 30 and transmit the latest contents to the vehicle system 20. Hereinafter, the map data providing system 11 and the contents providing system 12 may be collectively referred to as the charging station 10.

The vehicle system 20 may receive map data or various contents that need to be updated during vehicle charging through short-range communication with the charging station 10. The vehicle system 20 may be understood as including all software for the vehicle, including the navigation system.

The server 30 may periodically transmit the latest map data to the map data providing system 11 in the charging station 10. Furthermore, the server 30 may periodically transmit the latest contents to the contents providing system 12 in the charging station 10. Communication between the server 30 and the charging station 10 may be performed through a wired or wireless network.

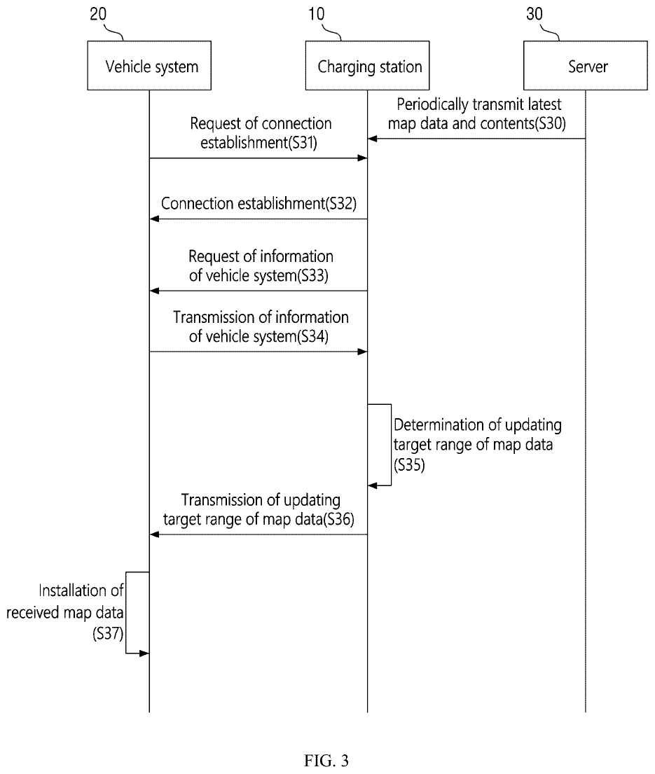

Next, operations of the method for updating navigation data according to one embodiment of the present disclosure are described based on a subject performing each of the operations, with reference to FIG. 3.

FIG. 3 is a signal flow diagram illustrating a method for updating navigation data according to an embodiment of the present disclosure. It should be noted that the operation as performed by each of the subjects 10, 20, and 30 shown in FIG. 3 are only an example, and the subject performing each operation may vary. For example, unlike S31 and S32 in FIG. 3, the charging station 10 may request the vehicle system 20 to establish a connection thereto, and the vehicle system 20 may create the connection to the charging station in response to the request from the charging station 10.

Referring to FIG. 3, the server 30 may periodically transmit the latest map data and the latest contents to the charging station 10 through the network in S30.

Thereafter, when the vehicle system 20 has approached the charging station 10 by a distance at which the vehicle system can communicate with the charging station 10, the vehicle system 20 may request the charging station 10 to establish a connection thereto to receive the map data or contents in S31. In response to this request, the charging station 10 may establish the connection to the vehicle system 20 in S32.

Afterwards, the charging station 10 may request information of the vehicle system 20 from the vehicle system 20 in S33. The information of the vehicle system 20 may include an expected charging time of the vehicle and version information of the map data of the vehicle system 20. The expected charging time of the vehicle is a measure used to estimate a time duration for which the vehicle will stay at the charging station 10. A time duration for which the map data may be updated may be predicted using the information about the expected charging time of the vehicle. The charging station 10 may determine a range of the map data by which the map data may be updated based on the time duration for which the map data may be updated.

The expected charging time of the vehicle may vary depending on a type of a charger positioned at the charging station and a charging mode set by the vehicle. For example, when the charger is a slow type charger, the expected charging time of the vehicle may be increased. When the charger is a rapid type charger, the expected charging time of the vehicle may be decreased.

The version information of the map data of the vehicle system 20 may be used to determine whether the navigation device of the vehicle system 20 requires an update of the map data. When the map data of the vehicle system 20 is the latest version, there is no need to update the map data of the vehicle system 20, so that unnecessary software updates may be avoided, thereby saving time and cost.

Upon receiving of the request of the information of the vehicle system, the vehicle system 20 may transmit the information of the vehicle system 20 including the expected charging time of the vehicle and the version information of the map data of the vehicle system 20 to the charging station 10 in S34. The charging station 10 may obtain the information of the vehicle system through step S34.

Upon obtaining the information of the vehicle system 20, the charging station 10 may determine the updating target range of the map data using the information of the vehicle system 20 in S35. For example, when the expected charging time of the vehicle is 15 minutes, the version of the map data of the vehicle system 20 is not the latest version, and a time required to download the latest version of the map data into the vehicle system 20 is 60 minutes, the vehicle system 20 may not have enough time to download an entirety of the latest version of the map data into the navigation system. In this case, the charging station 10 may select only a portion of the latest version of the map data and transmit the partial map data to the vehicle system 20. A criterion for selecting the partial map data may vary. In this regard, one solution may be to preferentially select map data that is close to the driving route set by the vehicle system 20. However, this is only an example, and the criterion for selecting the partial map data may be set to vary depending on the situation.

The detailed criterion for determining the updating target range of the map data of the vehicle system 20 by the charging station 10 is described in detail below after this section and has been omitted in this section.

When the charging station 10 has determined the updating target range of the map data of the vehicle system 20, the vehicle system 20 may update the map data based on the updating target range. In other words, the charging station 10 may transmit map data as an updating target to the vehicle system 20 in S36, and the vehicle system 20 may install the received map data in the navigation device within the vehicle system 20 via software update in S37.

According to an embodiment, the latest map data may be automatically updated without the navigations service user having to manually perform periodic software updates, thereby increasing the user's convenience.

In one embodiment, when the charging station 10 receives the vehicle system information from the vehicle system 20, the information of the vehicle system 20 may include personal schedule information registered in the vehicle system 20. The personal schedule information may be obtained by linking the vehicle system 20 with a personal electronic device such as a user's smartphone or tablet. For example, according to the personal schedule information registered in the vehicle system 20, there may be a case where there is an event scheduled at 16:00 near the destination. The current time is 15:30, and it is expected to take 20 minutes to reach the destination. In this case, the maximum time for which the vehicle system 20 may wait to update the map data is 10 minutes. It is assumed that it takes 30 minutes to update an entirety of the latest map data. In this regard, when the entirety of the latest map data has been updated, the user is likely to be late for an event scheduled at 16:00. Therefore, the charging station 10 may determine the updating target range of the map data that may be updated within 10 minutes so that the user is not late for the event scheduled at 16:00.

According to an embodiment, the updating target range of the map data may be determined based on the personal schedule of the navigation service user, thereby providing an excellent user experience to the user using the navigation service.

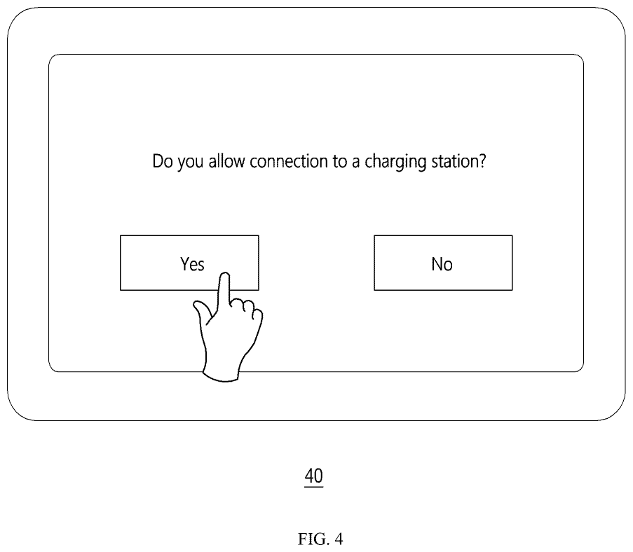

There may be a case where the charging station 10 requests the establishment of the connection between the charging station 10 and the vehicle system 20 in order to update the map data of the vehicle system 20. In this regard, there may be a case where the user determines that the map data of the vehicle system 20 does not need to be updated. Hereinafter, with reference to FIG. 4, an embodiment in which the user selects whether to allow the charging station 10 to connect to the vehicle system 20 is described.

FIG. 4 is a diagram showing a user screen for performing a method for updating navigation data according to an embodiment of the present disclosure.

In one embodiment, when establishing the connection between the charging station 10 and the vehicle system 20, the charging station 10 may receive information about whether the charging station 10 is allowed to be connected to the vehicle system 20 from the vehicle system 20. Referring to FIG. 4, the user may select whether to allow the charging station 10 to connect to the vehicle system 20 on the navigation screen 40. When the charging station 10 receives a response indicating that the vehicle system 20 allows the connection thereto, the charging station 10 may receive the information of the vehicle system 20 therefrom and determine the updating target range of the map data based on the information, and then, perform the update on the map data of the vehicle system 20 based on the determined updating target range. On the other hand, when the charging station 10 receives a response indicating that the vehicle system 20 does not allow the connection thereto, the charging station 10 cannot proceed with a series of processes for updating the map data of the vehicle system 20.

According to an embodiment, the navigation service user may select whether or not to allow the charging station 10 to access the vehicle system 20 such that the charging station updates the map data of the vehicle system 20, thereby increasing the convenience of using the navigation service.

While the charging station 10 transmits the map data as the updating target to the vehicle system 20, the user may have to wait in the vehicle for a long time. In this regard, when the charging station 10 provides the user with contents that may help the user spend the waiting time beneficially, the user's satisfaction in using the navigation service may be increased.

Hereinafter, a scheme in which the charging station 10 provides the contents to the vehicle system 20 while charging the vehicle is described.

When the charging station 10 has determined the updating target range of the map data of the vehicle system 20, the charging station 10 may determine the contents that may be able to be entirely played within the expected charging time of the vehicle. When the charging station 10 has determined the contents able to be entirely played within the expected charging time of the vehicle, the charging station 10 may stream the determined contents to a display screen mounted on the vehicle system 20 while transmitting the map data as the updating target to the vehicle system 20.

According to the present embodiment, while the charging station 10 transmits the map data as the updating target to the vehicle system 20, the user may watch useful contents and wait in the vehicle, so that the user's satisfaction in using the navigation service may be increased.

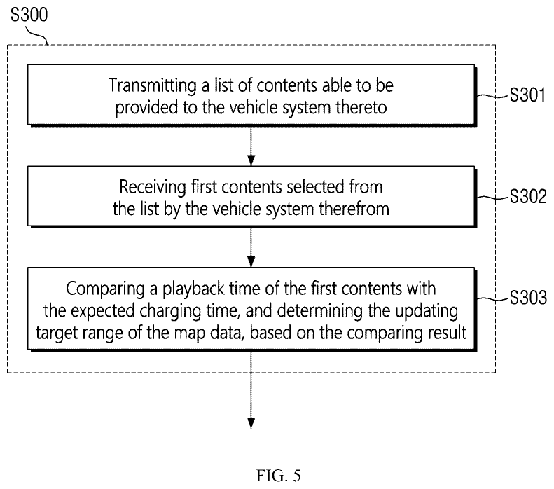

While the user charges the vehicle and the vehicle system 20 receives the latest map data, there may be specific contents that the user wants to watch or listen to. In this case, a scheme may be required that allows the user to directly select the contents and allows the vehicle system 20 to receive the latest map data during the contents playback time. Hereinafter, referring to FIG. 5, a method for determining the updating target range of the map data of the vehicle system 20 based on the time duration for which the contents is provided to the vehicle system is described.

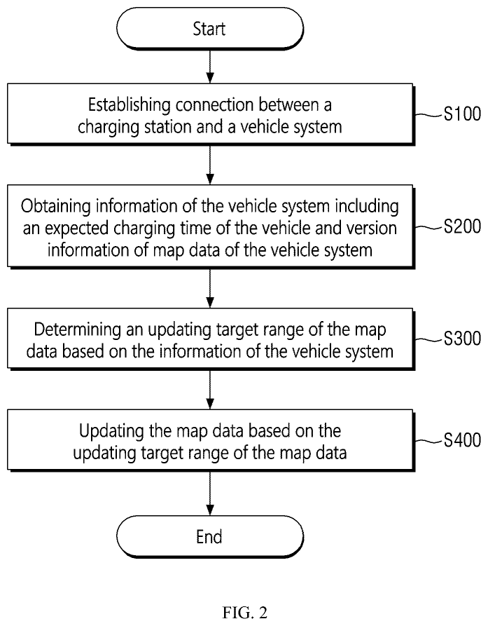

FIG. 5 is a diagram illustrating a detailed operation of the method for updating navigation data, as described above with reference to FIG. 2.

Referring to FIG. 5, when the charging station 10 has determined the updating target range of the map data of the vehicle system 20, the charging station 10 may transmit a list of contents which are able to be provided to the vehicle system 20 thereto in S301. The user may select first contents that he or she wants to playback from the list of contents displayed on the display screen mounted in the vehicle system 20.

Thereafter, the charging station 10 may receive the first contents selected by the vehicle system 20 therefrom in S302.

The charging station 10 may determine the updating target range of the map data of the vehicle system 20 based on a comparing result of the playback time of the first contents with the expected charging time of the vehicle in S303. In this regard, when the playback time of the first contents is smaller than the expected charging time of the vehicle, the updating target range of the map data of the vehicle system 20 may be determined based on the playback time.

For example, the playback time of the first contents may be 15 minutes and the expected charging time of the vehicle may be 30 minutes. The user may want to have watched an entirety of the first contents and then, leave the charging station 10. In this regard, a portion of the map data that may be updated within 15 minutes as the playback time of the first contents rather than the expected charging time of the vehicle may be determined as the updating target range of the map data of the vehicle system 20.

When the charging station 10 has determined the updating target range of the map data of the vehicle system 20 based on the playback time of the first contents, the charging station 10 may stream and play back the first contents to the display screen mounted on the vehicle system 20 while transmitting the map data to be updated to the vehicle system 20.

According to an embodiment, the navigation service user may directly select the contents and the vehicle system 20 may receive the latest map data during the contents playback time, thereby enhancing the user experience of the navigation service.

In one embodiment, the information of the vehicle system 20 acquired by the charging station 10 may include information about the driving route set by the vehicle system 20. In this regard, the expected charging time of the vehicle may not be enough time to download an entirety of the latest map data. In this case, the charging station 10 may determine the updating target range of the map data of the vehicle system 20 based on the driving route set by the vehicle system 20.

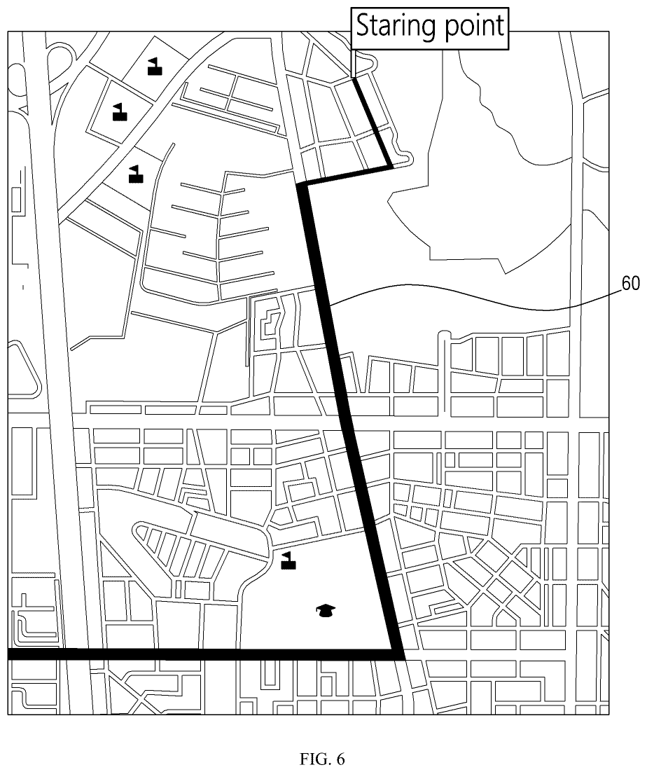

Referring to FIG. 6, the charging station 10 may determine a portion of the map data within a reference value from the driving route 60 set by the vehicle system 20 as the updating target range. According to an embodiment, although the vehicle system 20 cannot download the entirety of the latest map data from the charging station, the vehicle system may download at least the portion of the latest map data that is close to the driving route, thereby providing the user with the updated latest map data related to the driving route from the starting point to the destination.

Next, an embodiment is described in which the charging station 10 transmits the map data as the updating target to the vehicle system 20 and then, the vehicle system 20 completes the downloading of the map data.

In one embodiment, when the vehicle system 20 has completed the downloading of the map data, the vehicle system 20 may display the charging status of the vehicle and the status of the updated map data on the display screen. The status of the updated map data may display the version information of the updated map data and modifications/improvements thereof.

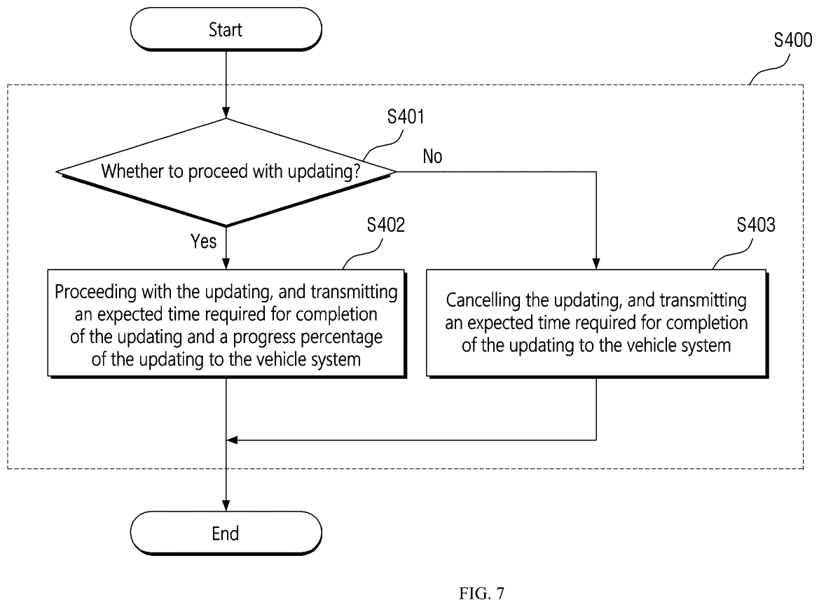

Hereinafter, with reference to FIG. 7, a scheme of dealing with a case in which the vehicle system 20 fails to normally complete the downloading of the map data is described.

In one embodiment, when the vehicle system 20 has not completed the updating target range of the map data, the vehicle system may determine whether to proceed with the updating in S401. The vehicle system 20 may allow the user to select whether to proceed with the updating through the display screen mounted on the vehicle and may determine whether to proceed with the updating based on the user selection.

When the user of the vehicle system 20 determines to proceed with the updating, the vehicle system 20 may transmit a signal indicating an intention to continue the updating to the charging station 10 in S402. The charging station 10 may transmit the updating target range of the latest map data to the vehicle system 20 such that the updating continues. The charging station 10 may transmit the expected time required for completion of the updating and a current progress percentage of the updating to the vehicle system 20. The vehicle system 20 may display information about the expected time required for the completion of the updating and the current progress percentage of the updating to the user through the display screen mounted on the vehicle.

In one embodiment, when the vehicle system 20 fails to complete the downloading of the updating target range of the map data, the vehicle system may determine whether to proceed with the updating in S401. The vehicle system 20 may allow the user to select whether to proceed with the updating through the display screen mounted on the vehicle and may determine whether to proceed with the updating based on the user selection.

When the vehicle system 20 determines not to proceed with the updating, the vehicle system 20 may transmit a signal indicating cancelling of the updating to the charging station 10 in S403. The charging station 10 may cancel the updating and, at the same time, transmit the expected time required for completion of the updating to the vehicle system 20. The vehicle system 20 may display the expected time required for completion of the updating on the display screen mounted on the vehicle to inform the user of the expected time required to complete the downloading of the latest map data.

According to an embodiment, the system may inform the navigation service user of the success or failure of updating of the map data and the status of the progress of the updating, thereby allowing the user to recognize the downloading status of the latest map data.

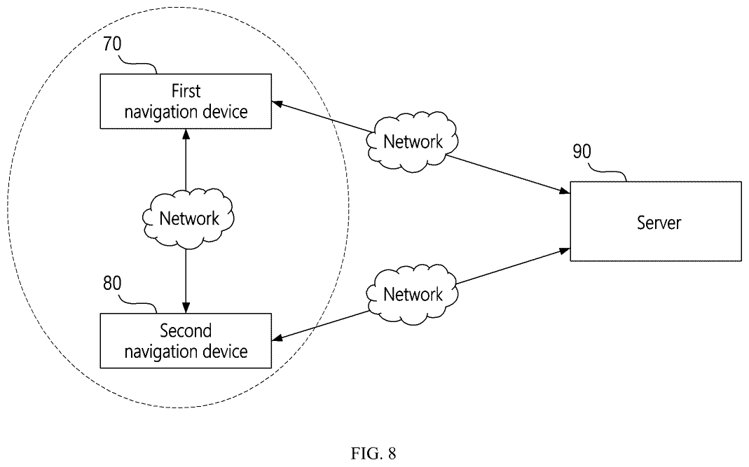

Next, with reference to FIGS. 8-12, a method for updating map data through communication between vehicles while the vehicle is driving or stopped is described.

With reference to FIG. 8, a system for updating navigation data according to the present embodiment is described.

The method for updating navigation data according to the present embodiment may be performed by one or more computing devices. Furthermore, some operations of the method for updating navigation data according to the present embodiment may be performed by a first computing device included in a system for updating the navigation data, and the remaining operations thereof may be performed by a second computing device included in the system for updating the navigation data. For example, some operations of the method for updating navigation data according to the present embodiment may be performed by an on-premise physical server, and the remaining operations thereof may be performed by a cloud compute instance. Hereinafter, it may be understood that when an entity performing each operation is omitted, the performing entity may be the system for updating the navigation data.

Referring to FIG. 8, a first navigation device 70 may be configured to receive a navigation service provided from a server 90 that provides the navigation service. The first navigation device 70 may transmit the position and driving route of the first navigation device 70 and the version information of the map data of the first navigation device 70 to the server 90. The server 90 may determine whether the map data of the first navigation device 70 needs to be updated and whether the updating thereof is possible or impossible, based on the received data.

A second navigation device 80 may be configured to receive a navigation service provided from the server 90. The second navigation device 80 may transmit the position and the driving route of the second navigation device 80, and the version information of the map data of the second navigation device 80 to the server 90.

When the server 90 determines that the map data of the first navigation device 70 is not the latest version based on the data transmitted from the first navigation device 70, the server may determine the second navigation device 80 which has at least a portion of the driving route that matches that of the first navigation device 70, which is positioned at a distance from the first navigation device at which short-range communication between the first navigation device 70 and the second navigation device 80 can be established, and which stores therein first map data necessary for updating the map data of the first navigation device 70.

The server 90 may transmit access information about the second navigation device 80 to the first navigation device 70.

The user of the second navigation device 80 may determine whether to provide the first map data through a display screen on the second navigation device 80.

When the user of the second navigation device 80 accepts to provide the first map data, the first navigation device 70 may receive the first map data from the second navigation device 80 that is capable of short-range communication with the first navigation device 70 and update the map data of the first navigation device 70. The short-range communication between the first navigation device 70 and the second navigation device 80 may be performed using V2V (Vehicle to Vehicle) communication.

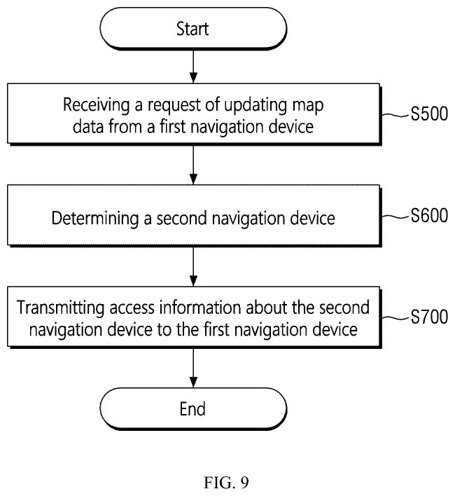

Hereinafter, with reference to FIG. 9, a method for updating navigation data using vehicle-to-vehicle communication according to an embodiment of the present disclosure is described.

FIG. 9 is a flowchart of a method for updating navigation data according to an embodiment of the present disclosure.

Referring to FIG. 9, the server 90 may receive a request of updating the map data of the first navigation device from the first navigation device 70 in S500. The updating request may be updating request of an entirety or a portion of the latest map data stored in the server 90. For example, the map data of which the first navigation device 70 requests the updating may be map data positioned at a close distance to the driving route of the first navigation device 70.

Thereafter, the server 90 may determine the second navigation device 80 that may transmit the map data that the first navigation device 70 has requested to update to the first navigation device 70 in S600. The server 90 may determine, as the second navigation device 80, as a navigation device which may store therein at least a portion of second map data that the first navigation device 70 has requested to update, and which has a current driving route matching at least a portion of a current driving route of the first navigation device 70, and which has a current position adjacent to a current position of the first navigation device 70 within a reference value.

The second navigation device 80 and the first navigation device 70 should be positioned within a distance from each other such that V2V communication therebetween may be performed. When the second navigation device 80 has the current driving route matching at least a portion of the current driving route of the first navigation device 70, it is likely that the second navigation device 80 and the first navigation device 70 may be positioned within a distance from each other such that V2V communication therebetween may be performed. Thus, when the server 90 determines the second navigation device 80, the server 90 considers the current position and the current driving route of the second navigation device 80.

After the server 90 has determined the second navigation device 80, the server 90 may transmit access information about the second navigation device 80 to the first navigation device 70 in S700. The access information about the second navigation device 80 may be login information, and the like, required for the first navigation device 70 to connect to the second navigation device 80 when the first navigation device 70 receives the second map data that the first navigation device 70 has requested to update toward the server 90 from the second navigation device 80.

According to the present embodiment, the navigation device built into the vehicle system may be updated through communication between vehicles while the vehicle is driving or stopped, so that the navigation data updating may be automatically performed, thereby saving time and communication cost.

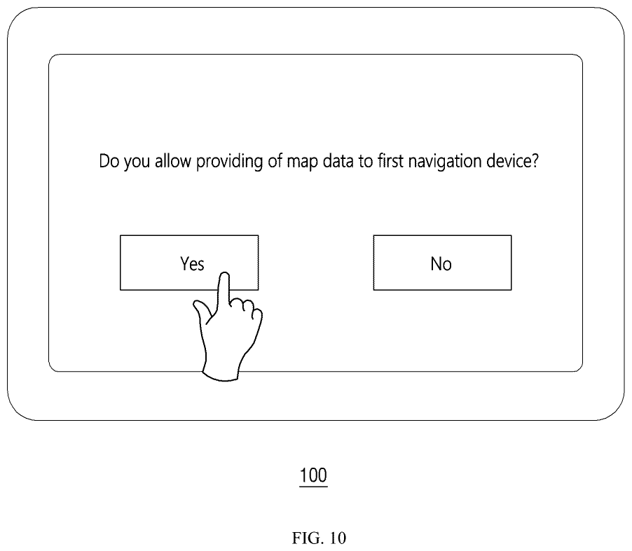

When the server 90 determines the second navigation device 80, there may be a case where the user of the second navigation device 80 does not agree to providing the first navigation device 70 with the second map data that the first navigation device 70 has requested to update. Hereinafter, referring to FIG. 10, an embodiment regarding whether the user of the second navigation device 80 will accept providing the second map data in the above-described situation is described.

FIG. 10 is a diagram illustrating a user screen for performing a method for updating navigation data according to an embodiment of the present disclosure.

Referring to FIG. 10, when the server 90 determines the second navigation device 80 that satisfies a predetermined condition, the server 90 may display a screen 100 regarding whether to accept providing the second map data to the first navigation device 70 on the display screen of the second navigation device 80.

When the user of the second navigation device 80 touches a ‘Yes’ button, the server 90 may transmit the access information about the second navigation device 80 to the first navigation device 70.

When the user of the second navigation device 80 touches a ‘No’ button, the second navigation device does not accept the provision of the second map data, such that the server 90 may search again for another second navigation device 80 that satisfies the predetermined condition.

According to an embodiment, there is an advantage in that intention of the user of the second navigation device 80 may be respected to resolve a security problem that may arise due to indiscriminate sharing of map data.

When the user of the second navigation device 80 accepts the provision of the second map data to the first navigation device 70, the second navigation device 80 should be positioned within a reference value from the first navigation device 70 to perform V2V communication therebetween in order for the second navigation device 80 to transmit the second map data to the first navigation device 70. Therefore, the user of the second navigation device 80 needs to drive the vehicle along the current driving route that matches at least a portion of the current driving route of the first navigation device 70, and also needs to drive the vehicle at a driving speed set so that the second navigation device 80 and the first navigation device 70 may perform V2V communication while maintaining a certain distance therebetween. When the user of the second navigation device 80 drives the vehicle along an expected driving route at an expected driving speed, the server 90 may provide a reward for the user of the second navigation device 80 to activate a method for updating navigation data according to the present disclosure.

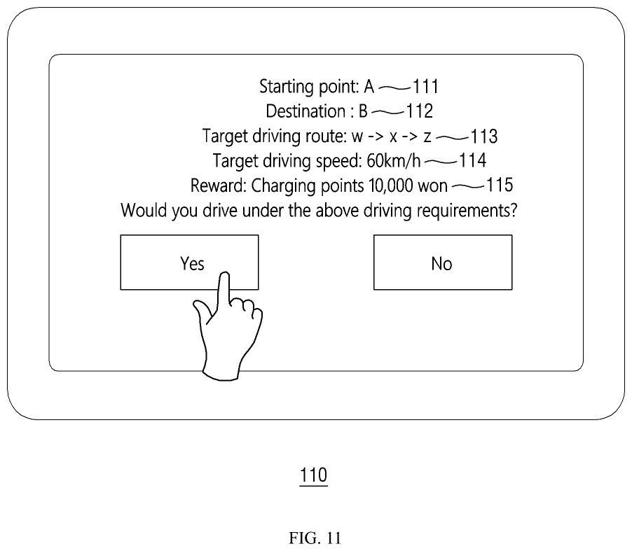

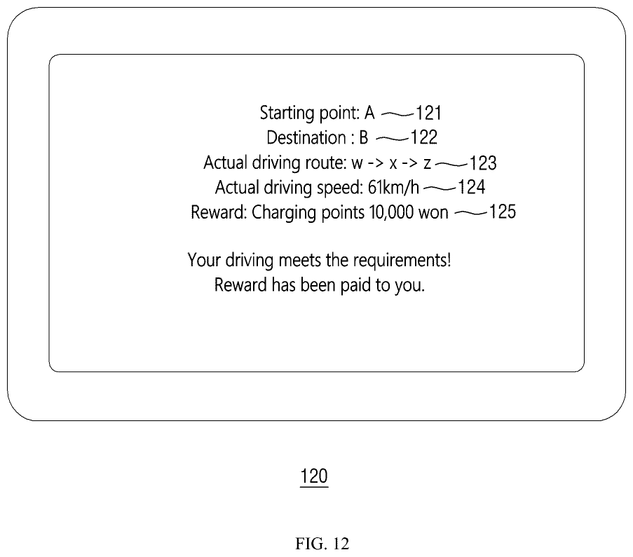

Hereinafter, with reference to FIGS. 11-12, an embodiment in which the server 90 provides the reward to the second navigation device 80 when the user of the second navigation device 80 drives the vehicle along a recommended driving route or at a recommended driving speed is described in detail.

FIGS. 11-12 are diagrams illustrating a user screen for performing a method for updating navigation data according to an embodiment of the present disclosure.

In one embodiment, when the server 90 has received, from the second navigation device 80, a signal indicating that the second navigation device accepts the provision of the second map data to the first navigation device 70, the server 90 may recommend a first driving speed or a first driving route from a starting point to a destination to the second navigation device 80. In this regard, the server 90 may transmit, to the second navigation device 80, information about a first reward that is paid when the user of the second navigation device 80 complies with the first driving speed or the first driving route. Information about the first reward may be displayed on the display screen of the second navigation device 80.

For example, referring to FIG. 11, followings are displayed on a display screen 110 of the second navigation device 80: a starting point 111 of the second navigation device 80 is A, a destination 112 thereof is B, a target driving route 113 recommended by the server 90 is w->x->z, a target driving speed 114 recommended by the server 90 is 60 km/h, and the reward that the second navigation device 80 may obtain when the second navigation device 80 complies with the target driving route 113 and the target driving speed 115 is 10,000 won in charging points.

The second navigation device 80 may display the above information on the display screen of the second navigation device 80. Thus, the user of the second navigation device 80 may touch a ‘yes’ or ‘no’ button. The user of the second navigation device 80 may determine whether to accept providing the second map data to the first navigation device 70.

When the user of the second navigation device 80 complies with the first driving speed or the first driving route, the server 90 may transmit the first reward to the second navigation device 80 and pay the first reward to the user of the second navigation device 80.

For example, referring to FIG. 11, it is assumed that while the user of the second navigation device 80 drives the vehicle from the starting point 121 A to the destination 122 B, the driving route 123 is w->x->z, and the actual driving speed 124 is 61 km/h.

The user of the second navigation device 80 has complied with the target driving route 113 and has driven the vehicle at a speed faster by 1 km/h than the target driving speed 114. However, it is common that the target driving speed 114 and the actual driving speed 124 are different from each other by a tolerance. Thus, when the actual driving speed differs from the target driving speed by about 10% or smaller of the target driving speed, this case is considered as the user of the second navigation device 80 complying with the target driving speed. In other words, the user of the second navigation device 80 has complied with the target driving route 113 and the target driving speed 114. Therefore, the server 90 pays a reward of 10,000 won in charging points to the user of the second navigation device 80.

According to an embodiment, the first navigation device 70 may receive the map data of which the updating request has been made from the second navigation device 80 and perform the updating thereof. At the same time, when the user of the second navigation device 80 drives the vehicle along the expected driving route at the expected driving speed, by the server 90 may pay the reward to the user of the second navigation device 80. Thus, there is an advantage in that the method for updating the navigation data according to the present disclosure may be activated.

In one example, even when the user of the second navigation device 80 complies with both the first driving route and the first driving speed provided from the server 90, there may be a case where the user of the first navigation device 70 fails to receive the second map data from the second navigation device 80 due to an accident or the like while driving the vehicle.

Even in this case, in order to guarantee the expected benefit that the user of the second navigation device 80 may receive the reward for complying with the first driving route or the first driving speed, even when the update of the second map data is not completed due to an abnormal behavior of the driver of the vehicle in which the first navigation device 70 is installed, the server 90 may transmit the reward supposed to be paid to the second navigation device 80 thereto.

In one embodiment, when the first navigation device 70 receives the access information about the second navigation device 80 from the server 90 and has completed the updating of the map data which the first navigation device 70 has requested to update toward the server 90 through communication with the second navigation device 80, the first navigation device 70 may generate an updating result report. The updating result report may include information about the updating details and the time of communication with the second navigation device 80 to perform the updating. The first navigation device 70 may display the updating result report on the display screen of the first navigation device 70 and may transmit the report to the server 90. The server 90 may store therein the updating result report as data for modifying and supplementing the service for a method for updating navigation data according to the present disclosure.

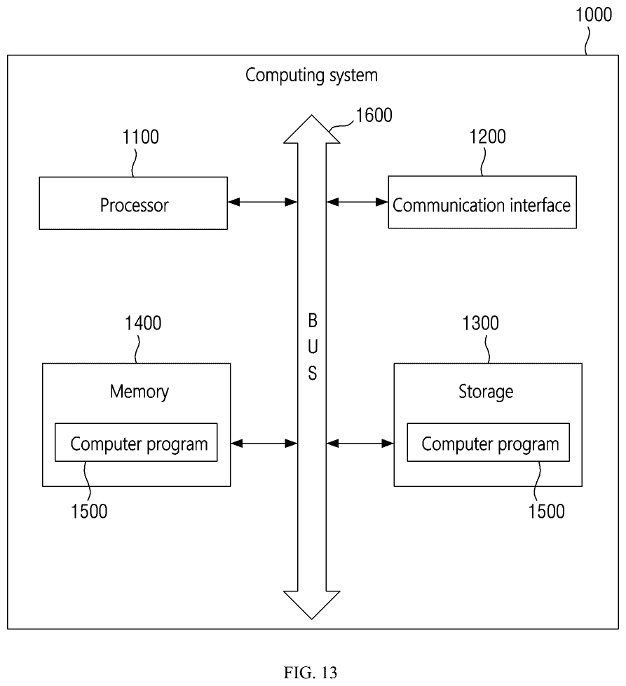

With reference to FIGS. 1-13, the method for updating navigation data according to some embodiments of the present disclosure has been described above. Hereinafter, with reference to FIG. 13, a hardware configuration of a navigation system is described.

FIG. 13 is an example hardware configuration diagram of a computing system 1000 according to some embodiments of the present disclosure. The computing system 1000 corresponds to the system for updating the navigation data as described above.

As illustrated in FIG. 13, the computing system 1000 may include one or more processors 1100, a bus 1600, a communication interface 1200, a memory 1400 that loads thereon a computer program executed by the processor 1100, and a storage 1300 that stores therein a computer program 1500.

However, FIG. 13 only shows the components related to embodiments of the present disclosure. Therefore, a person having ordinary skill in the art to which the present disclosure belongs may know that other general components may be included in addition to the components shown in FIG. 13. In other words, the computing system 1000 may include various components in addition to the components shown in FIG. 13. Furthermore, in some cases, the computing system 1000 may be configured in a structure in which some of the components shown in FIG. 13 is omitted. Hereinafter, each of the components of the computing system 1000 is described.

The processor 1100 may control all operations of the components of the computing system 1000. The processor 1100 may be configured to include at least one of a CPU (Central Processing Unit), an MPU (Micro Processor Unit), an MCU (Micro Controller Unit), a GPU (Graphics Processing Unit), or any further type of a processor well known in the technical field of the present disclosure. Furthermore, the processor 1100 may perform computations of at least one application or program for executing operations/methods according to some embodiments of the present disclosure. The computing system 1000 may have one or more processors.

Next, the memory 1400 may store therein various data, commands, and/or information. The memory 1400 may load therein the computer program 1500 from the storage 1300 to execute operations/methods according to some embodiments of the present disclosure. The memory 1400 may be embodied as a volatile memory such as RAM. However, the present disclosure is not limited thereto.

Next, the bus 160 may provide a communication function between the components of the computing system 1000. The bus 1600 may be embodied as various types of buses such as an address bus, a data bus, and a control bus.

Next, the communication interface 1200 may support wired and wireless Internet communication of the computing system 1000. Furthermore, the communication interface 540 may support various communication schemes other than Internet communication. To this end, the communication interface 1200 may be configured to include a communication module well known in the technical field of the present disclosure.

Next, the storage 1300 may non-temporarily store therein one or more computer programs 1500. The storage 1300 may be configured to include a non-volatile memory such as Read Only Memory (ROM), Erasable Programmable ROM (EPROM), Electrically Erasable Programmable ROM (EEPROM), flash memory, a hard disk, a removable disk, or any form of computer-readable recording medium well known in the art to which the present disclosure belongs.

Next, the computer program 1500 may include one or more instructions that cause the processor 1100 to perform the operations/methods according to various embodiments of the present disclosure when being loaded into the memory 1400. In other words, the processor 1100 may execute one or more loaded instructions to perform the operations/methods according to various embodiments of the present disclosure.

For example, the computer program 1500 may include instructions for establishing connection between a charging station and a vehicle system; instructions for obtaining information of the vehicle system including an expected charging time of the vehicle and version information of map data of the vehicle system; instructions for determining an updating target range of the map data based on the information of the vehicle system; and instructions for updating the map data based on the updating target range of the map data.

Furthermore, for example, the computer program 1500 may include instructions for receiving a request of updating map data from a first navigation device, wherein the first navigation device is configured to receive a navigation service provided from the computing device; instructions for determining a second navigation device, wherein the second navigation device stores therein at least a portion of the map data, and has a current driving route matching at least a portion of a current driving route of the first navigation device and has a current position adjacent to a current position of the first navigation device within a reference value, wherein the second navigation device is configured to receive the navigation service provided from the computing device; and instructions for transmitting access information about the second navigation device to the first navigation device.

So far, a variety of embodiments of the present disclosure and the effects according to embodiments thereof have been mentioned with reference to FIGS. 1-13. The effects according to the technical idea of the present disclosure are not limited to the forementioned effects, and other unmentioned effects may be clearly understood by those having ordinary skill in the art from the description of the specification.

The technical features of the present disclosure described so far may be embodied as computer readable codes on a computer readable medium. The computer readable medium may be, for example, a removable recording medium (compact disk (CD), digital versatile disc (DVD), Blu-ray disc, universal serial bus (USB) storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those having ordinary skill in the art should appreciate that many variations and modifications can be made to embodiments without substantially departing from the principles of the present disclosure. Therefore, the disclosed embodiments of the disclosure are used in a generic and descriptive sense only and not for purposes of limitation.

What is claimed is:

1. A method for updating navigation data, the method being performed by a computing device, the method comprising:
establishing connection between a charging station and a vehicle system;
obtaining information of the vehicle system, including an expected charging time of the vehicle and version information of map data of the vehicle system;
determining an updating target range of the map data based on the information of the vehicle system; and
updating the map data based on the updating target range of the map data.

2. The method of claim 1, wherein the information of the vehicle system includes personal schedule information registered in the vehicle system.

3. The method of claim 1, wherein establishing the connection includes receiving, from the vehicle system, a signal indicating whether or not to allow access to the vehicle system.

4. The method of claim 1, wherein determining the updating target range of the map data includes determining contents able to be entirely played within the expected charging time.

5. The method of claim 4, wherein updating the map data includes providing the determined contents to the vehicle system during the expected charging time.

6. The method of claim 1, wherein determining the updating target range of the map data includes:
transmitting, to the vehicle system, a list of contents able to be provided to the vehicle system;
receiving, from the vehicle system, first contents selected from the list by the vehicle system;
comparing a playback time of the first contents with the expected charging time; and
determining the updating target range of the map data, based on a result of comparing the playback time of the first contents with the expected charging time.

7. The method of claim 6, wherein determining the updating target range of the map data, based on the result of comparing the playback time of the first contents with the expected charging time includes:
upon determination that the playback time is less than the expected charging time, determining the updating target range of the map data based on the playback time.

8. The method of claim 6, wherein updating the map data includes playing back the first contents during the playback time.

9. The method of claim 1, wherein the information of the vehicle system includes information on a driving route set by the vehicle system,
wherein determining the updating target range of the map data includes determining the updating target range of the map data based on the driving route set by the vehicle system.

10. The method of claim 1, wherein updating the map data includes:
when updating the map data based on the updating target range has not been completed, determining whether the vehicle system proceeds with updating the map data; and
upon determination that the vehicle system proceeds with updating the map data, proceeding with updating the map data, and, at the same time, transmitting an expected time required for completion of updating the map data and a progress percentage of updating the map data to the vehicle system.

11. The method of claim 1, wherein updating the map data includes:
when updating the map data based on the updating target range has not been completed, determining whether the vehicle system proceeds with updating the map data; and
upon determination that the vehicle system does not proceed with updating the map data, cancelling updating the map data, and, at the same time, transmitting an expected time required for completion of updating the map data to the vehicle system.

12. A method for updating navigation data, the method being performed by a computing device, the method comprising:
receiving a request of updating map data from a first navigation device, wherein the first navigation device is configured to receive a navigation service provided from the computing device;
determining a second navigation device, wherein the second navigation device stores therein at least a portion of the map data, and has a current driving route matching at least a portion of a current driving route of the first navigation device and has a current position adjacent to a current position of the first navigation device within a reference value, wherein the second navigation device is configured to receive the navigation service provided from the computing device; and
transmitting access information about the second navigation device to the first navigation device.

13. The method of claim 12, wherein determining the second navigation device includes receiving a signal indicating whether the second navigation device accepts providing the map data in response to the request of updating the map data.

14. The method of claim 13, wherein receiving the signal indicating whether the second navigation device accepts providing the map data includes:
upon receiving the signal indicating that the second navigation device accepts providing the map data, providing a first driving speed to the second navigation device; and
when a vehicle of the second navigation device complies with the first driving speed, providing a first reward to the vehicle of the second navigation device.

15. The method of claim 14, wherein receiving the signal indicating whether the second navigation device accepts providing the map data includes transmitting information about the first reward to the second navigation device.

16. The method of claim 14, wherein providing the first reward includes providing the first reward to the vehicle of the second navigation device even when updating the map data has not been completed due to an abnormal behavior of a driver of a vehicle of the first navigation device.

17. The method of claim 13, wherein receiving the signal indicating whether the second navigation device accepts providing the map data includes:
upon receiving the signal indicating that the second navigation device accepts providing the map data, providing a first driving route to the second navigation device; and
when a vehicle of the second navigation device complies with the first driving route, providing a second reward to a vehicle of the second navigation device.

18. The method of claim 17, wherein receiving the signal indicating whether the second navigation device accepts providing the map data includes transmitting information about the second reward to the second navigation device.

19. The method for updating the navigation data of claim 17, wherein providing the second reward includes providing the second reward to the vehicle of the second navigation device even when the updating of the map data has not been completed due to an abnormal behavior of a driver of a vehicle of the first navigation device.

20. A system for updating navigation data, the system comprising:
a communication interface;
a memory configured to load thereon a computer program; and
at least one processor configured to execute the computer program to:
establish connection between a charging station and a vehicle system;
obtain information of the vehicle system, the information including an expected charging time of the vehicle and version information of map data of the vehicle system;
determine an updating target range of the map data based on the information of the vehicle system; and
update the map data based on the updating target range of the map data.
